(19) United States
(12) Patent Application Publication
(10) Pub. No.: US 2014/0244802 A1
(43) Pub. Date: Aug. 28, 2014

(54) METHOD AND SYSTEM FOR EMBEDDING IDENTIFIED USER INFORMATION INTO SOFTWARE

(71) Applicants: Vagish Narang, Santa Clara, CA (US); Swati Tewari, Santa Clara, CA (US)

(72) Inventors: Vagish Narang, Santa Clara, CA (US); Swati Tewari, Santa Clara, CA (US)

(21) Appl. No.: 13/781,560

(22) Filed: Feb. 28, 2013

(51) Int. Cl. H04L 29/00

(52) U.S. Cl. CPC H04L 29/00
USPC 709/219

(57) ABSTRACT

A method and system comprises communicating, to a server, a signal initiated by a user actuation. The signal comprises at least the user's identifying information and location information. The server receives the signal and dynamically tags an executable computer code with at least, in part, the received signal. The server further configures the tagged executable computer code using at least, in part, the received signal to form a user specific computer code. The server makes available the user specific computer code for the user. The user specific computer code is accessed and received to be executed and uniquely configured for the user during the execution without user intervention for configuration.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to identifying user information. More particularly, one or more embodiments of the invention relate to a method of identifying user information for embedding into software.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a server is a physical computer dedicated to run one or more services, to serve the needs of the users of other computers on the network. Depending on the computing service that it offers it could be a database server, file server, mail server, print server, web server, or gaming server.

Typically, a computer user provides personal information on a computer without entering the information. User context may be identified through the location of the web URL, location of the user, and user account settings. The information may provide useful data for marketers.

Typically, in communications or computer systems, a configuration is an arrangement of functional units according to their nature, number, and chief characteristics. Often, configuration pertains to the choice of hardware, software, firmware, and documentation. The configuration affects system function and performance.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of the steps for an exemplary method for identification, in accordance with an embodiment of the present invention;

FIG. 2 illustrates a block diagram for an exemplary method for identification, in accordance with an embodiment of the present invention; and

FIG. 3 illustrates a typical computer system that, when appropriately configured or designed, can serve as an exemplary method for identification, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The present invention will now be described in detail with reference to embodiments thereof as illustrated in the accompanying drawings.

There are various types of methods for identification that may be provided by preferred embodiments of the present invention. In one embodiment of the present invention, the method for identification may provide a method to tag and configure a computer code with user identification information. The user identification information may then be copied onto the computer code for generating a user specific computer code. The user may then dynamically and in real time utilize the user specific computer code. In this manner, the computer code may function without requiring the user to reenter user information.

In one embodiment of the present invention, the user may actuate a signal from a browser, through a link. The signal may include information about the user, including, without limitation, user account settings, user location, and location of the web URL. The signal may transmit through the internet to a data storage portion. In some embodiments, the data storage portion may include a server that functions to receive the user information and dynamically tag the computer code based on user identity, location, and account. In some embodiments, the user information may be stored or transfered via a cloud service or one or more cookies. The data storage portion may be operable to configure the computer code to form a user specific computer code by utilizing the user information. The configuration may be dynamic and in real time. The configuration may be triggered by various actuators, including, without limitation, a web link, an email or a queue. The user specific computer code may provide a user context to the computer program, and additional computer programs. The data storage portion may be operable to additionally tag and configure subsequent computer codes with the same user identification. In some embodiments, the user may access the user specific computer code that is configured with information about the user. The user may access the user specific computer code dynamically and in real time by downloading the computer code. In this manner, the user may immediately download and run the computer code, and the computer code may be configured with the user identification, including user settings and current user information.

Those skilled in the art, in light of the present teachings, will recognize that time, effort, and processing energy may be optimized by not requesting user information for every execution of the computer code; thus resulting in enhanced usability and reduced steps. This may be specifically helpful in cases, including, without limitation, online meetings, remote support and remote access. For example, without limitation, when a skilled computer user assists an unskilled computer user, the unskilled computer user may actuate a link on a website to start screen sharing and receive assistance, since the unskilled computer user's information is tagged on the computer code. In some embodiments, new versions of the computer code may be downloaded without reentering the user information, since the data storage portion is operable to tag and configure the new version computer code with the user information. The installation steps are, thus minimized. In this manner, the publisher of the computer code is only required to publish a single copy of the computer code, even though the target copies may include variations of the original computer code based on user identity and location.

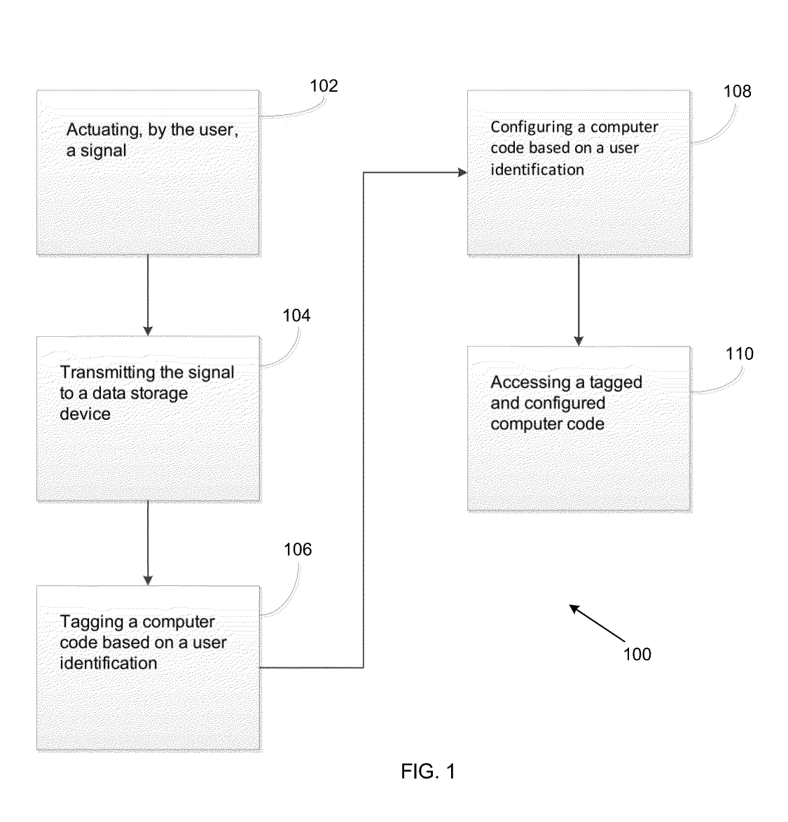

FIG. 1 illustrates a flowchart diagram of the steps for an exemplary method for identification, in accordance with an embodiment of the present invention. In the present invention, the method for identification 100 may embed a computer code with a user identification for providing user identification information to the computer code, and all subsequent computer codes. The computer code may include, without limitation, software, scripts, cookies, and object oriented programming language. A data storage portion may receive the user information for tagging and configuring the computer code. The data storage portion may include, without limitation, a server, a memory storage device, and a processor. In an initial Step 102, the user may actuate a signal from a browser, through a link. In some embodiments, the user may click a link on a browser from a processor. In some embodiments, the user information may be sent automatically. Non-limiting examples of information include, but not limited to, which URL the user reached, how many times user has visited, information of past visits, information of past actions and/or other information from cookies. In some embodiments, the signal may include information about the user, including, without limitation, user account settings, user location, and location of the web URL. The URL location may be detected and identified based on the processor's location. The user may have at least one account setting that is also detected. The user may further have a location where a computer code is accessed, which is also detected and identified. However, in other embodiments, the user may have additional identification information that may be detected. In a Step 104, the signal may transmit through the internet to a data storage portion. However, in other embodiments, the signal may transmit through various networks, including, without limitation, a LAN network, WiFi, radio signals, and an intranet. In some embodiments, the data storage portion may include a remote server. In one alternative embodiment, the signal may be encrypted.

In a Step 106, the data storage portion may function to receive the user information and dynamically tag the computer code based on user identity, location, and account. In Step 108, the data storage portion may be operable to configure the computer code to form a user specific computer code by utilizing the user information. The following is a non-limiting example of a high level snippet of code that may be used to process a file and control a flow.

_readUserInputArr << location, ipaddress, session, cookie
*paramsToApplyArr = getParams(_readUserInputArr)
validateAndProcessParams(paramsToApplyArr)
encryptedParams = encrypt(paramsToApplyArr,
SYS_ENCRPTION_ALG)
filecopy(originSrc, destSrc)
tagUserParams(destSrc, encryptedParams)
pushFile(destSrc)
applyChanges(destSrc, decryptAndReadParams( ))
initUserInterface( )

In this manner, the data storage portion may provide a user context to the computer program, and additional computer programs. The data storage portion may be operable to tag and configure subsequent computer codes with the same user identification. The configuration may be dynamic and in real time. The configuration may be triggered by various actuators, including, without limitation, a web link, an email or a queue. The data storage portion may provide a unique signature to the user specific computer code. The unique signature may be applied to subsequent computer codes accessed by the user.

In a Step 110, the user may access a user specific computer code that contains information about the user. The user may access the computer code dynamically and in real time by downloading the computer code. In this manner, the user may immediately download and run the computer code, and the computer code may be configured with the user identification, including user settings and current user information. In one alternative embodiment, the user may select the information to be tagged and configured by the data storage portion. In another embodiment, the computer code may be generated and transmitted through any electronic trigger, including, without limitation email and response to other user's actions such as conducting transactions online. In one alternative embodiment, the user may access the computer code in an email preconfigured with the user information. In some embodiments, the data storage portion may tag and configure the computer code prior to the user downloading the computer code. The user information may be used while configuring a user interface and functionality of the application, without asking the user for any additional information, since all the information is part of the exe based on the user account, user settings, user history, and the location that the user downloaded the computer code. In some embodiments, the user information sent may include data about the user that is saved for future marketing and analyticis targeted towards the user.

Those skilled in the art, in light of the present teachings, will recognize that time, effort, and processing energy may be optimized by not requesting user information for every excecution of the computer code; thus resulting in enhanced usability and reduced steps. This may be specifically helpful in cases, including, without limitation, online meetings, remote support and remote access. For example, without limitation, when a skilled computer user assists an unskilled computer user, the unskilled computer user may actuate a link on a website to start screen sharing and receive assistance, since the unskilled computer user's information is tagged on the computer code.

In one embodiment of the present invention, new versions of the computer code may be downloaded without requiring reentering the user information, since the data storage portion is operable to tag and configure the new version computer code with the user information. Consequently, the user may not be required to enter any key or serial number before starting to use the software. The installation steps are, thus minimized. In this manner, the publisher of the computer code is only required to publish a single copy of the computer code, even though additional target copies may include variations of the original computer code based on user identity and location.

In one embodiment of the present invention, the computer code may include the user information before and after being copied. In yet another embodiment, the user specific computer code may be tagged and transmitted to the user. In one alternative embodiment, the data storage portion may tag additional information about the user including, without limitation, websites visited, speed of typing keystrokes, and amount of time spent viewing a website.

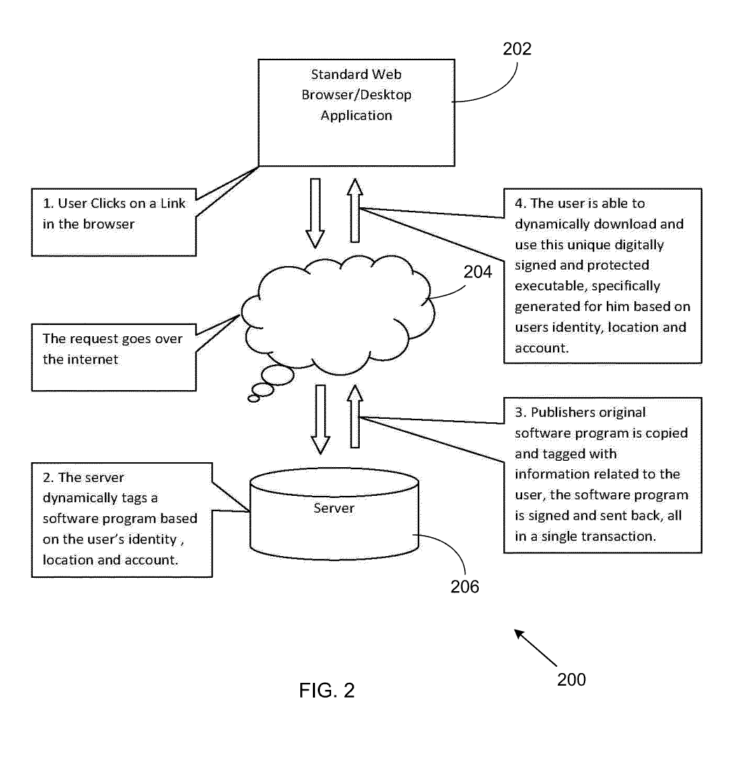

FIG. 2 illustrates a block diagram for an exemplary method for identification, in accordance with an embodiment of the present invention. In the present invention, the method for identification 200 may provide a method for a data storage portion to tag and configure a computer code with user information. Those skilled in the art, in light of the present teachings, will recognize that the computer code may be updated with additional user information and then at runtime the software may dynamically detect and pick the configuration options from that data. The user information may then be tagged and configured onto the computer code for generating a user specific computer code. The user may then dynamically and in real time access the user specific computer code. In this manner, the computer code may execute without requiring the user to reenter user information.

In one embodiment of the present invention, the user may click on a link for a web browser in a desktop application 202, thereby transmitting a signal. The signal may transmit through the internet 204 to a data storage portion 206. However, in other embodiments, the signal may transmit through various networks, including, without limitation, a LAN network, WiFi, radio signals, and an intranet. In some embodiments, the data storage portion may include a remote server. In some embodiments, the data storage portion may be operable to configure the computer code to form a user specific computer code by utilizing the user information. In this manner, the data storage portion may provide a user context to the computer program, and additional computer programs. The data storage portion may be operable to tag and configure subsequent computer codes with the same user identification. The user may then access the user specific computer code containing information about the user.

In one embodiment of the present invention, the method for identification may utilize various platforms and operating systems, including, without limitation, Linux, any variant of Linux, Windows or any server operating system for detecting user context, identity and then tagging and configuring the software. The client software that may be downloaded may include, without limitation, Windows, Mac, and any suitable operating system. In some embodiments, the software that is downloaded and used by the end user may be on the desktop or any mobile device.

In alternate embodiments, cloud services may be utilized in the system. In one alternate embodiment, the user specific computer code may be uploaded to the user and to storage on a cloud account for the user. In another alternate embodiment, the user specific computer code may only be uploaded to a cloud account for the user from which the user may access the computer code. In both of these embodiments, the data storage portion need not locally store the user specific computer code for each user. Users may access the cloud stored computer code at future times, such as, but not limited to reinstallation. In some alternate embodiments, the cloud storage may only be maintained for a limited time such as, but not limited to, unitl a new version is available or the user reliquishes his account. In other alternate embodiments, the user specific computer code may configured for as an executable from the cloud. In this case, the user specific computer code is not stored on the user's system and is to be accessed from the cloud each time the user wishes to run it.

In an alternate embodiment, the user information includes the platform and/or the operating system the user is using. The data storage portion may then select a compatable computer code to tag and configure. In another alternate embodiment, the user information includes the script interpreters installed. The data storage portion may then select a compatable script computer code to tag and configure.

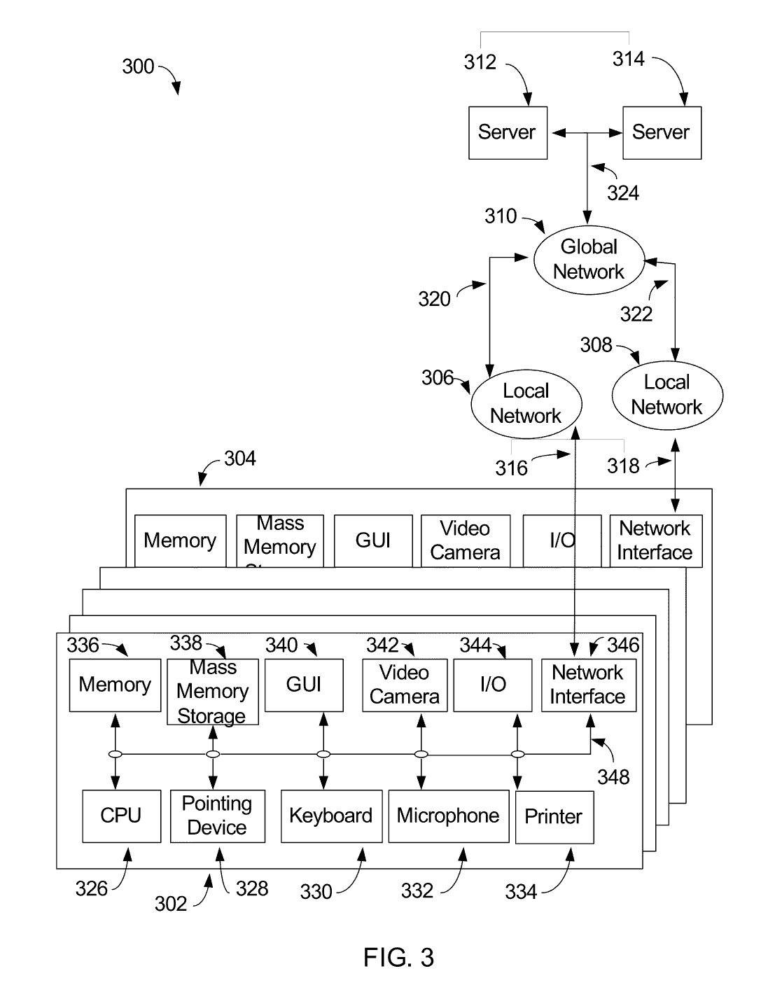

FIG. 3 illustrates a typical computer system that, when appropriately configured or designed, can serve as an exemplary method for identification, in accordance with an embodiment of the present invention. In the present invention, a communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones, smartphones and tablets.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a method for identifying user information to embed into software according to the present invention will be apparent to those skilled in the art. Various aspects of the invention have been described above by way of illustration, and the specific embodiments disclosed are not intended to limit the invention to the particular forms disclosed. The particular implementation of the method for identifying user information to embed into software may vary depending upon the particular context or application. By way of example, and not limitation, the method for identifying user information to embed into software described in the foregoing were principally directed to client applications; however, similar techniques may instead be applied to any software application, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

1. A method comprising the steps of:
communicating, to a server, a signal initiated by a user actuation, said signal comprising at least the user's identifying information and location information, said server receiving said signal and dynamically tagging an executable computer code with at least, in part, said received signal, said server further configuring said tagged executable computer code using at least, in part, said received signal to form a user specific computer code, said server making available said user specific computer code for the user;
accessing said user specific computer code; and
receiving said user specific computer code to be executed and uniquely configured for the user during said execution without user intervention for configuration.

2. The method as recited in claim 1, in which said server tags and configures subsequent executable computer codes to form subsequent user specific computer codes available for the user.

3. The method as recited in claim 1, in which said user activation further initiates a detection and identification of said identifying information and location information.

4. The method as recited in claim 1, in which said user activation comprises a user's clicking on a web link.

5. The method as recited in claim 1, in which said identifying information at least comprises the user's account information, account settings and location.

6. The method as recited in claim 1, in which said location information at least comprises a URL of the web link.

7. The method as recited in claim 1, in which said executable computer code comprises client software being operable for conducting online meetings, remote support or remote access.

8. The method as recited in claim 1, in which said server configures said tagged executable computer code by embedding information into said computer code.

9. The method as recited in claim 1, in which said user specific computer code uniquely configures the user's interface and functionality of said computer code.

10. A system comprising:
a client being configured to be operable to communicate a signal initiated by a user actuation, said signal comprising at least the user's identifying information and location information, said client being further configured to be operable to access a user specific computer code and receive said user specific computer code to be executed and uniquely configured for the user during said execution without user intervention for configuration; and
a server being configured to be operable to receive said signal and dynamically tag an executable computer code with at least, in part, said received signal, said server further being configured to be operable to configure said tagged executable computer code using at least, in part, said received signal to form a user specific computer code, said server making available said user specific computer code for said client to access;

11. The system as recited in claim 10, in which said server tags and configures subsequent executable computer codes to form subsequent user specific computer codes available for the user.

12. The system as recited in claim 10, in which said user activation further initiates a detection and identification of said identifying information and location information.

13. The system as recited in claim 10, in which said user activation comprises a user's clicking on a web link.

14. The system as recited in claim 10, in which said identifying information at least comprises the user's account information, account settings and location.

15. The system as recited in claim 10, in which said location information at least comprises a URL of the web link.

16. The system as recited in claim 10, in which said executable computer code comprises client software being operable for conducting online meetings, remote support and remote access.

17. The system as recited in claim 10, in which said server configures said tagged executable computer code by embedding information into said computer code.

18. The system as recited in claim 10, in which said user specific computer code uniquely configures the user's interface and functionality of said computer code.

19. A non-transitory computer-readable storage medium with an executable program stored thereon, wherein the program instructs a processor to perform the following steps:
communicating, to a server, a signal initiated by a user actuation, said signal comprising at least the user's identifying information and location information, said server receiving said signal and dynamically tagging an executable computer code with at least, in part, said received signal, said server further configuring said tagged executable computer code using at least, in part, said received signal to form a user specific computer code, said server making available said user specific computer code for the user;
accessing said user specific computer code; and
receiving said user specific computer code to be executed and uniquely configured for the user during said execution without user intervention for configuration.

20. The program instructing the processor as recited in claim 19, in which said user activation further initiates a detection and identification of said identifying information and location information, said user activation comprises a user's clicking on a web link, said identifying information at least comprises the user's account information account settings and location, said location information at least comprises a URL of the web link, said executable computer code comprises client software being operable for conducting online meetings, remote support, remote access said server configures said tagged executable computer code by embedding information into said computer code, said user specific computer code uniquely configures the user's interface and functionality of said computer code, and said server tags and configures subsequent executable computer codes to form subsequent user specific computer codes available for the user.
